(19) United States
(12) Patent Application Publication
(10) Pub. No.: US 2010/0269985 A1
(43) Pub. Date: Oct. 28, 2010

(54) INTERCHANGEABLE WINDOW TREATMENT FOR A ROMAN-STYLE SHADE

(75) Inventors: Michael Hanley, Smithfield, RI (US); Leo E. LaBarre, Woonsocket, RI (US); Mathew A. Mello, Coventry, RI (US); Vincent J. DeSanto, Lincoln, RI (US)

Correspondence Address: BARLOW, JOSEPHS & HOLMES, LTD., 101 DYER STREET, 5TH FLOOR, PROVIDENCE, RI, 02903, US

(73) Assignee: KENNEY MANUFACTURING CO., Warwick, RI (US)

(21) Appl. No.: 12/829,871

(22) Filed: Jul. 2, 2010

Related U.S. Application Data
(63) Continuation-in-part of application No. 29/362,812, filed on Jun. 1, 2010.
(60) Provisional application No. 61/223,914, filed on Jul. 8, 2009.
(60) Provisional application No. 61/348,413, filed on May 26, 2010.

(51) Int. Cl. A47H 5/00; E06B 9/24; E06B 9/42

(52) U.S. Cl. 160/84.04; 160/368.1; 160/323.1; 160/330

(57) ABSTRACT

A window treatment is disclosed. The window treatment includes a panel having a front portion, a rear portion, a top edge and a bottom edge. A plurality of guides extends from the rear portion of the panel. The guides are configured and arranged to allow a lifting mechanism to slide therethrough. The guides may further include a clip portion configured and arranged to attached to a window treatment and a guide portion extending from the clip portion that is configured and arranged to slidably receive an edge of a lifting mechanism therein

### CROSS-REFERENCE TO RELATED APPLICATIONS

The present patent document claims priority to earlier filed U.S. Provisional Patent Application Ser. Nos. 61/223,914, filed on Jul. 8, 2009, and 61/348,413, filed on May 26, 2010, and is a continuation in part of U.S. Design Patent Application Ser. No. 29/362812, filed on June. 1, 2010, the entire contents of all of which are incorporated herein by reference.

### BACKGROUND OF THE INVENTION

1. Field of the Invention

The present patent document relates generally to window treatments and more specifically to an interchangeable window treatment for a Roman-style shade.

2. Background of the Related Art

Roman-style shades are well known in the art. However, one disadvantage with Roman-style shades is that they do not easily permit the window treatment to be removed and replaced. In fact, the window treatment is often not removable at all from the head rail. Therefore, there is a perceived need for a window treatment for a Roman-style shade that permits the window treatment to be easily removed and replaced.

### SUMMARY OF THE INVENTION

The present invention solves the problems of the prior art by providing a window treatment that can be easily removed and attached to a shade. In particular the window treatment includes a front portion and rear portion with a top, left, right and bottom edges. A number of fasteners are located on the top edge of the rear portion window treatment and near the bottom edge of the rear portion of the window treatment. The fasteners at the top edge are configured to attach to a head rail of a shade assembly and the fasteners near the bottom edge are configured to attach to a lifting mechanism of the shade assembly. The window treatment further includes a number of guides on the rear portion of the window treatment that guide the lifting mechanism in order to form decorative pleats in the window treatment as it is raised by the lifting mechanism of the shade assembly.

### BRIEF DESCRIPTION OF THE DRAWINGS

These and other features, aspects, and advantages of the present invention will become better understood with reference to the following description, appended claims, and accompanying drawings where:

FIG. 1 is a front view of a preferred embodiment of the window treatment of the present invention;

FIG. 2 is a rear view of a preferred embodiment of the window treatment of the present invention;

FIG. 3 is a rear view of a lifting mechanism and head rail assembly of a shade;

FIG. 4 is a front view of a user separating the fasteners at the top edge of the window treatment from the reciprocal fastener on the head rail of the shade assembly;

FIG. 5 is a rear view of a user separating the fasteners near the bottom edge of the window treatment from the reciprocal fastener on the lifting mechanism of the shade assembly;

FIG. 6 is a rear view of the preferred embodiment of the window treatment of the present invention attached to a shade assembly;

FIG. 7a is a close up view of a guide engaged with a pocket on the window treatment and the lifting mechanism of the shade assembly;

FIG. 7b is a close up view of a user partially removing a guide from the pocket on the window treatment and the lifting mechanism of the shade assembly;

FIG. 7c is a close up view of a user partially removing a guide from the pocket on the window treatment and wholly separating the guide from the lifting mechanism of the shade assembly;

FIG. 8a is a perspective view of a clip used as a guide on the window treatment of the present invention;

FIG. 8b is a side view of a clip used as a guide on the window treatment of the present invention;

FIG. 9a is a front view of the preferred embodiment of the window treatment of the present invention being partially lifted by the lifting mechanism of the shade assembly;

FIG. 9b is a front perspective view of the preferred embodiment of the window treatment of the present invention being partially lifted by the lifting mechanism of the shade assembly;

FIG. 10a is a rear view of the preferred embodiment of the window treatment of the present invention being partially lifted by the lifting mechanism of the shade assembly;

FIG. 10b is a rear perspective view of the preferred embodiment of the window treatment of the present invention being partially lifted by the lifting mechanism of the shade assembly;

FIG. 11a is a rear view of a alternative window treatment of the present invention showing the use of a unitary wire loop as guides;

FIG. 11b is a rear view of a alternative window treatment of the present invention showing the use of wire hooks as guides;

FIG. 11c is a rear view of a alternative window treatment of the present invention showing the use of a unitary rod as guides; and

FIG. 11d is a rear view of a alternative window treatment of the present invention showing the use of a cloth pocket as guides.

### DESCRIPTION OF THE PREFERRED EMBODIMENT

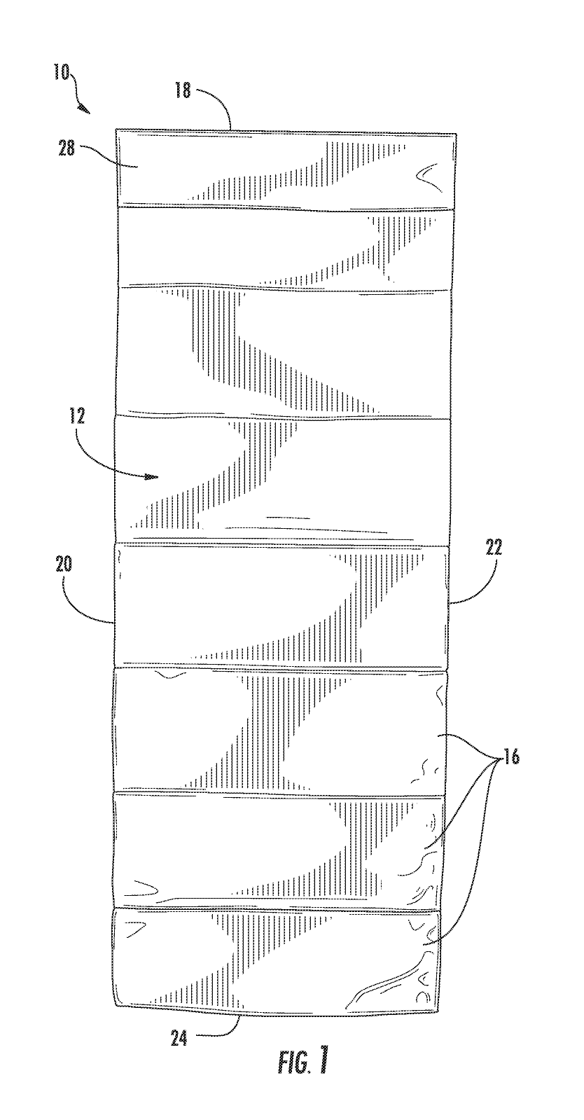

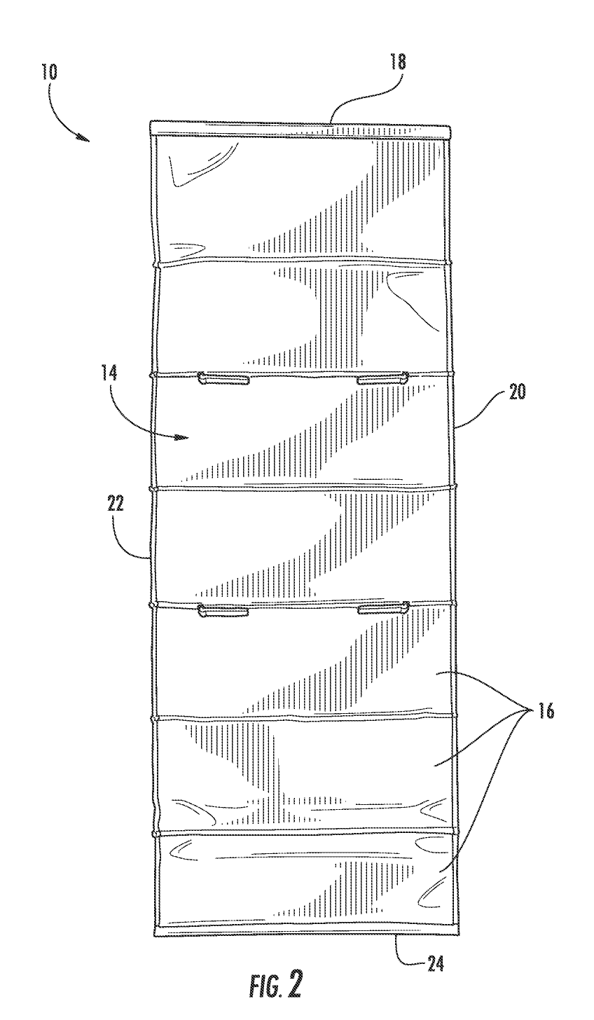

Referring now to the FIGS. 1 and 2, the window treatment of the present invention is shown generally at 10. The window treatment 10 has a decorative front portion 12 and a rear portion 14. The window treatment 10 may include multiple panels 16 or be a single large panel. The window treatment 10 further includes a top edge 18, a left side edge 20, a right side edge 22 and a bottom edge 24. The window treatment 26 may further include an optional valance portion 28 depending from the top edge 18 of the window treatment 10.

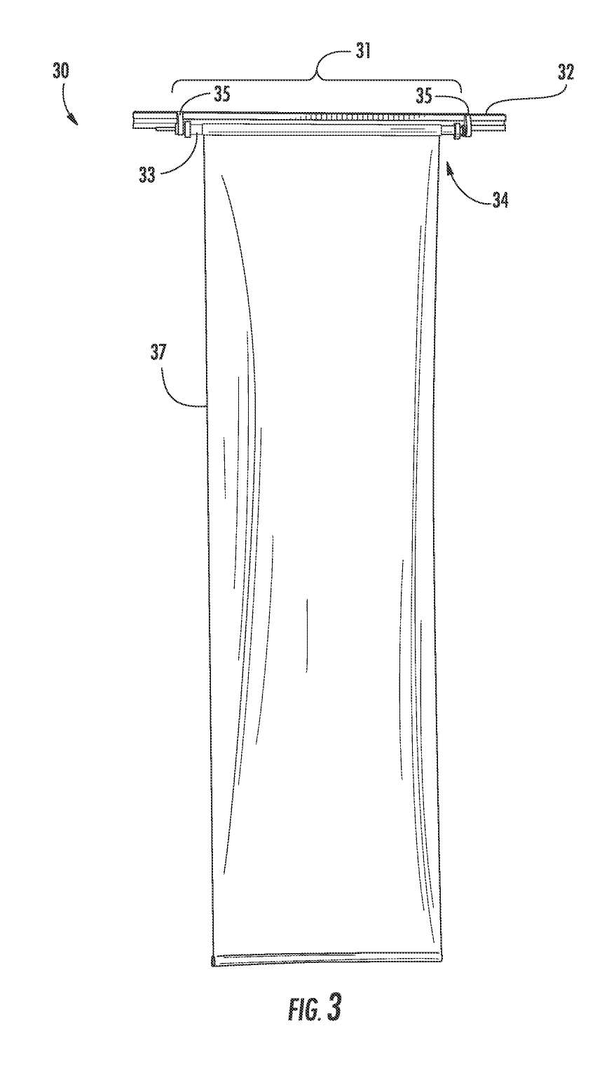

Referring now to FIG. 3, an exemplary shade assembly is shown generally at 30. The shade assembly 30 includes a support assembly 31, a head rail 32 and a lifting mechanism 34. The head rail 32 supports the window treatment 10 as further described below. The support assembly 31 supports the head rail 32 and lifting mechanism 34. The lifting mechanism 34 is configured to raise and lower the window treatment 10, which is further described below.

The lifting mechanism 34 includes a take up member 33 rotatably attached to the support assembly 31. A lifting member 37 is attached to the take up member 33. The take up member 33 is configured and arranged to gather and release the lifting member 37.

The support assembly 31 may include one or more brackets 35. The brackets 35 are configured to be mounted to a wall opening, such as a doorway, window opening or casement with fasteners, such as screws, nails or bolts. The brackets 35 may be configured to mount horizontally, vertically or at another angle to the wall or window opening. Additional spacers and braces may be used to support the brackets 35 against the wall opening. The head rail 32 may be connected to the brackets 35 of the support assembly 31.

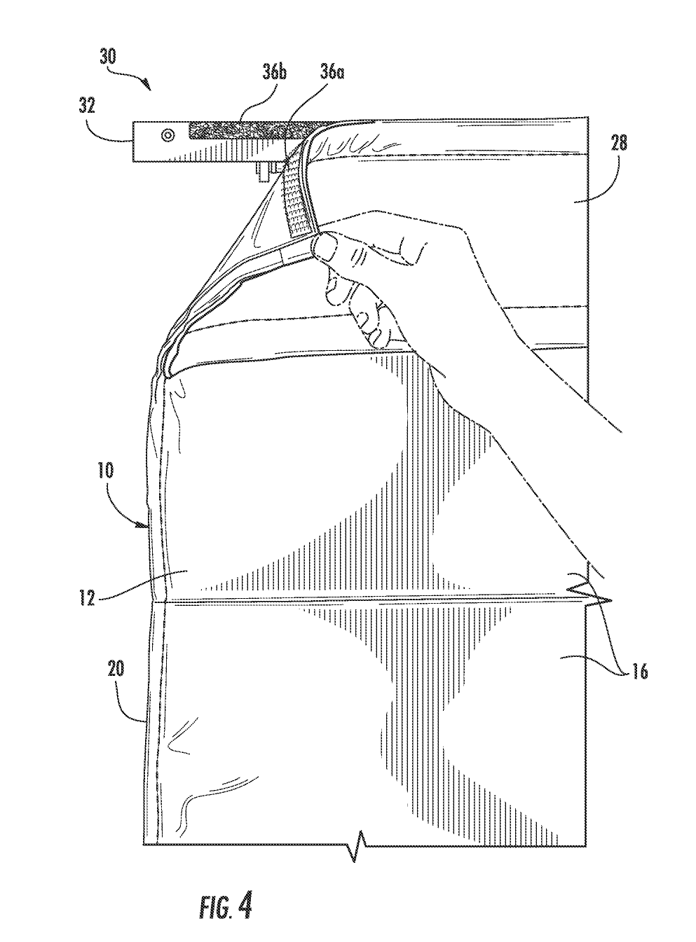

Referring now to FIG. 4, one or more fasteners 36a are provided at the top edge 18 of the window treatment 10, which are configured to attach to a head rail 32 of a shade assembly 30. The fasteners 36a may be hook-and-loop fasteners, eyes to be fitted over hooks or buttons, snaps, zippers, and the like. The head rail 32 has the mating half 36b of the fasteners 36a to allow the window treatment 10 to be secured thereto.

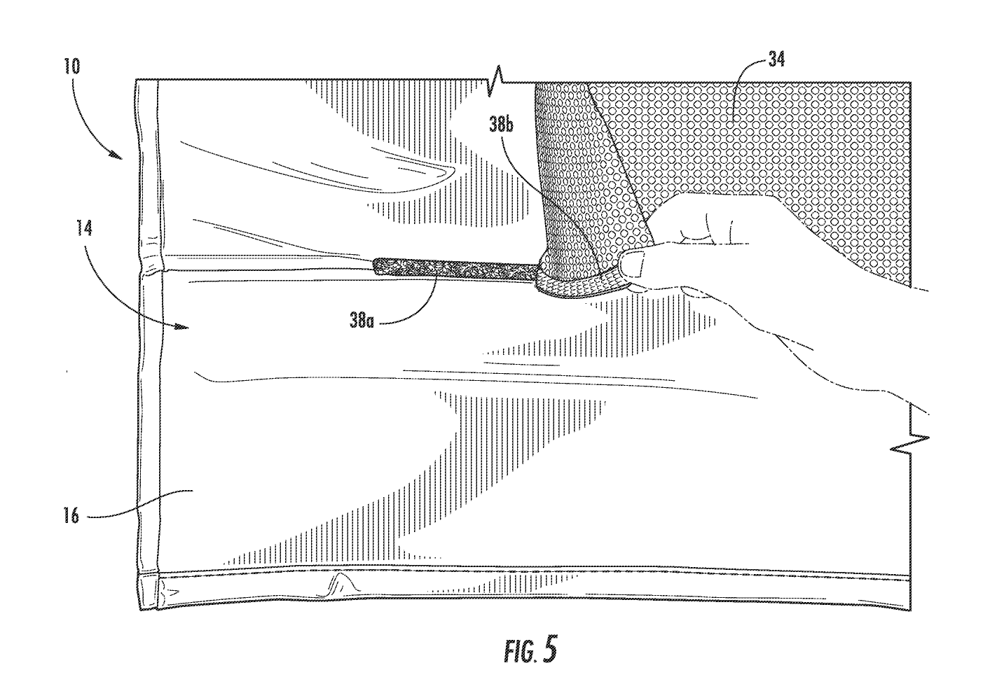

Referring now to FIG. 5, one or more fasteners 38a are provided near the bottom edge 24 of the window treatment 10, which are configured to attach to the lifting mechanism 34 of the shade assembly 30. The fasteners 38a may be hook-and-loop fasteners, eyes to be fitted over hooks or buttons, snaps, zippers, and the like. The lifting mechanism 34 on the shade assembly 30 has the mating half 38b of the fasteners 38a to allow the window treatment 10 to be secured thereto. Operation of the lifting mechanism 34 of the shade assembly 30 raises the window treatment 10 as further described below.

Because fasteners 36a, 36b, 38a, 38b are used, the window treatment 10 may be removed from the shade assembly 30. This feature permits the user replace the window treatment 10 with another window treatment, e.g. a light summer window treatment may be replaced with a heavier winter window treatment, or a holiday patterned decorative window treatment, such as a pumpkin-themed pattern for Halloween for instance, may be hung to celebrate a particular holiday. This feature also permits the window treatment 10 to be easily cleaned because the user can take down and wash or clean the window treatment 10.

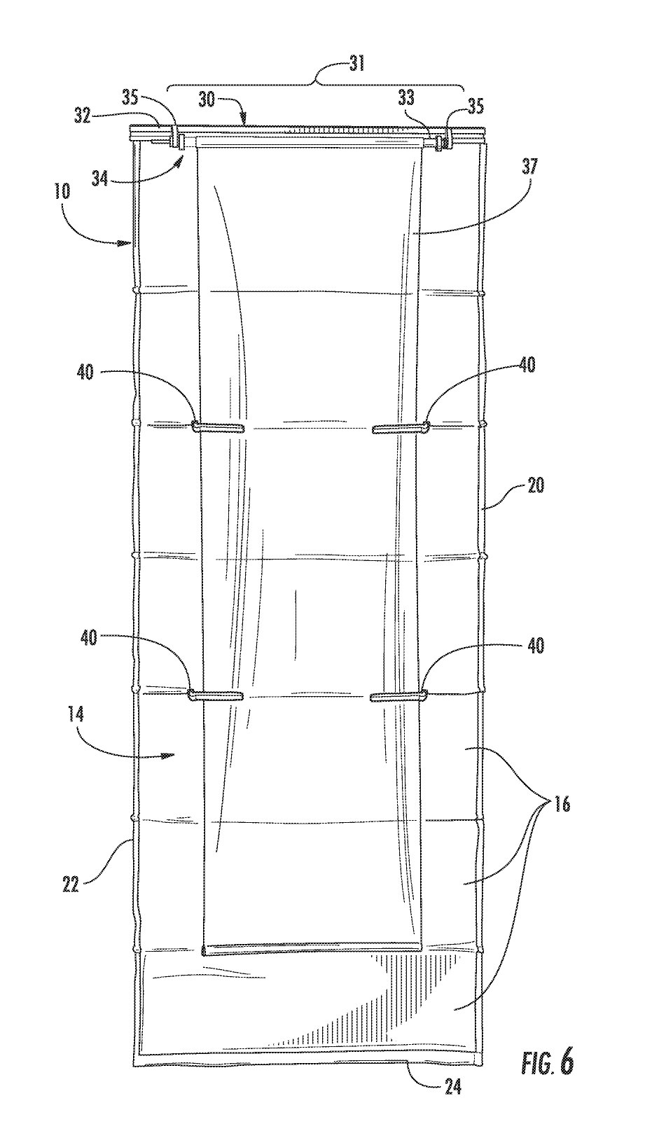

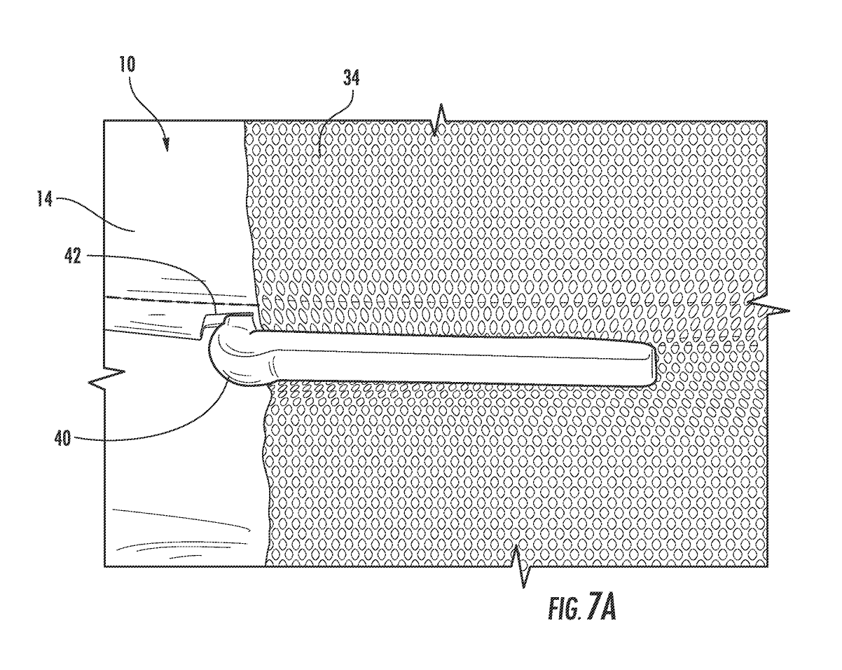

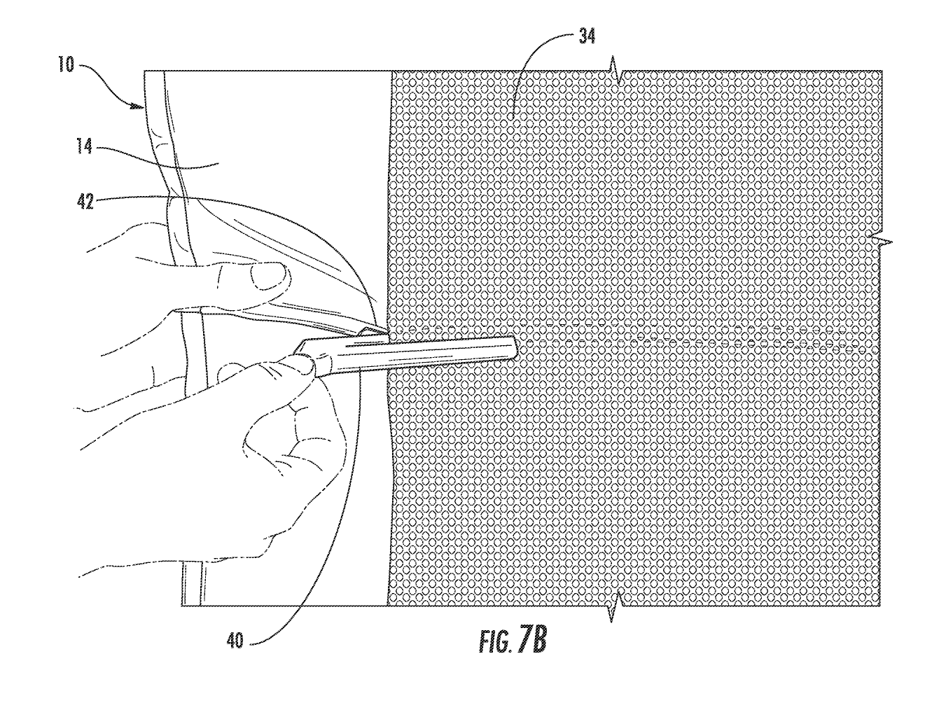

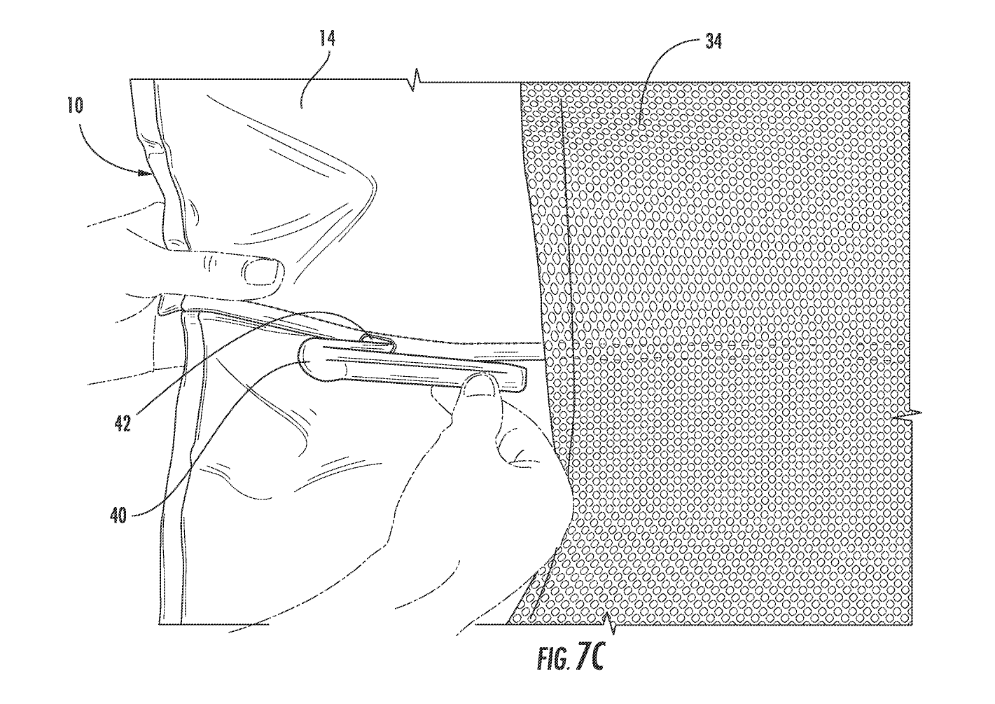

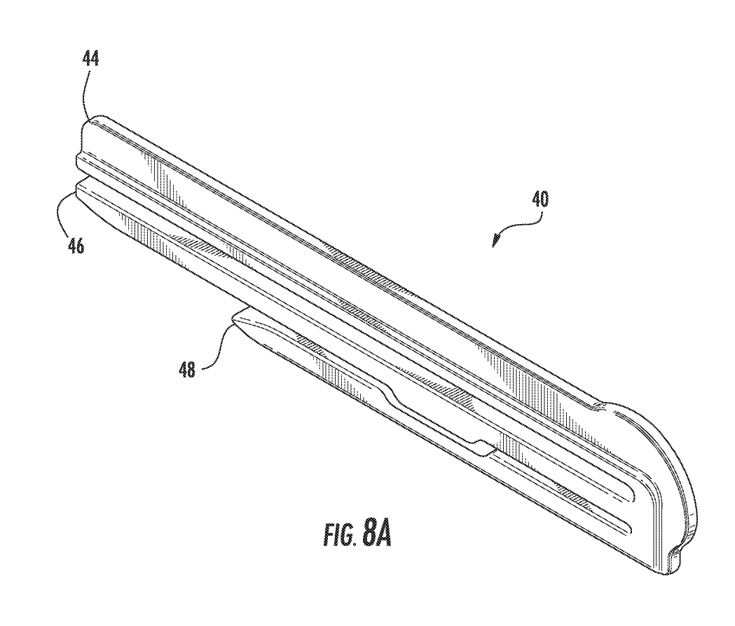

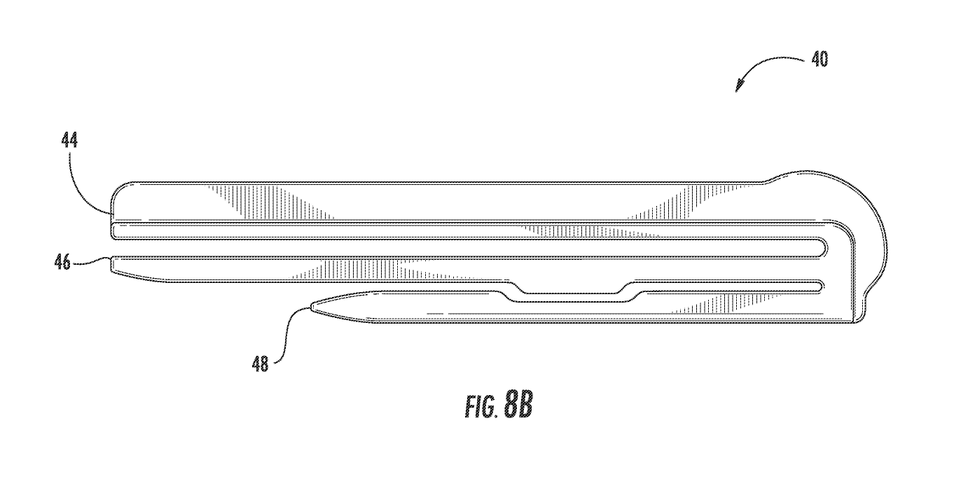

Referring now to FIGS. 6, 7a-7c, 8a and 8b, further included on the rear portion 14 of the window treatment 10 are a number of spaced-apart guides. The guides may be formed as a pair of opposing clips 40 retained in a pocket 42 formed on the rear portion 14 of the window treatment 10. The clips 40 include a first guide element 44 and a second guide element 46 spaced apart from the first guide element 44. A slot is formed between the first guide element 44 and the second guide element 46. The clip 40 further includes a toothed retaining element 48 spaced apart from the second guide element 46 that is received in the pocket 42 on the rear portion 14 of the window treatment 10. The second guide element 46 may also include reciprocal teeth facing the retaining element 48. The teeth on the retaining element 48 and the second guide element 46 prevent the clip 40 from being accidentally dislodged from the pocket 42 on the window treatment 10.

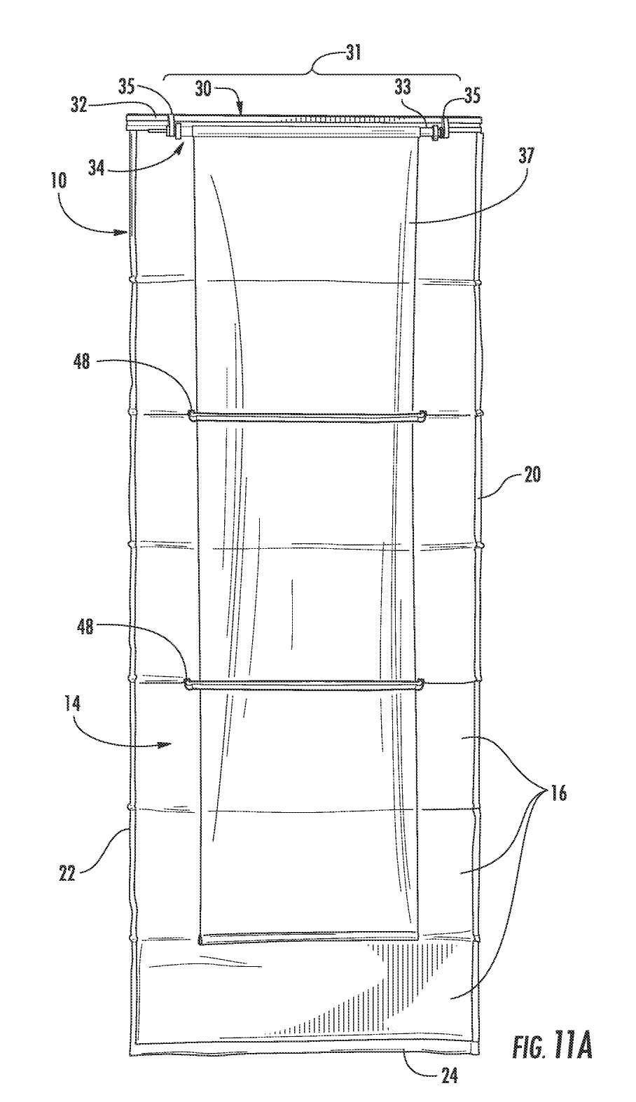

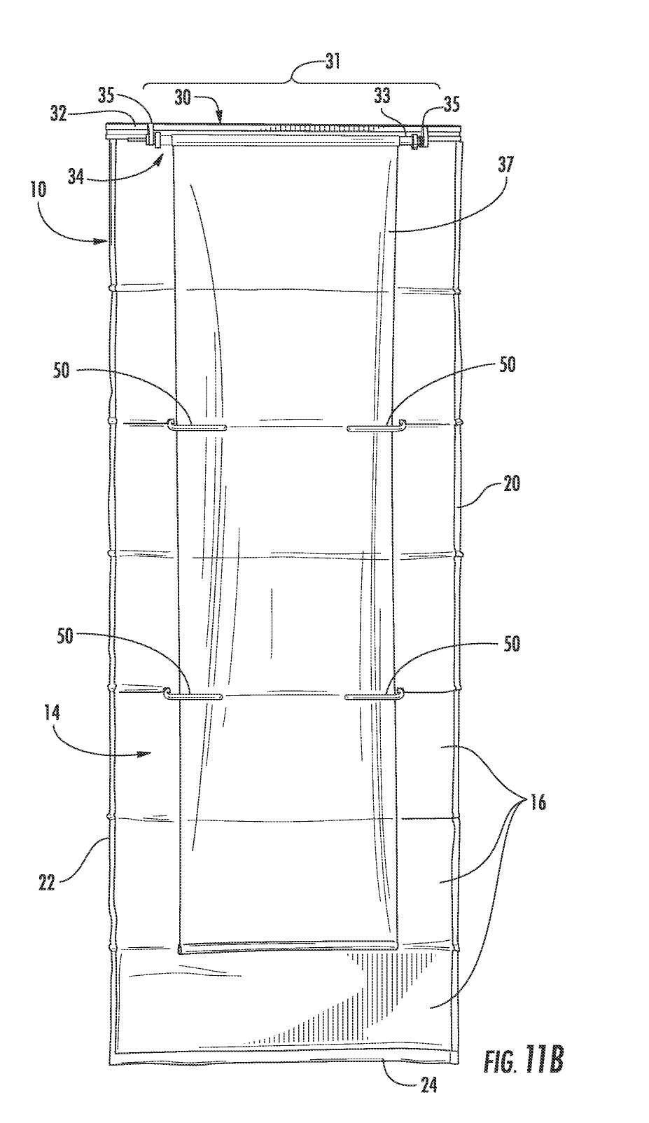

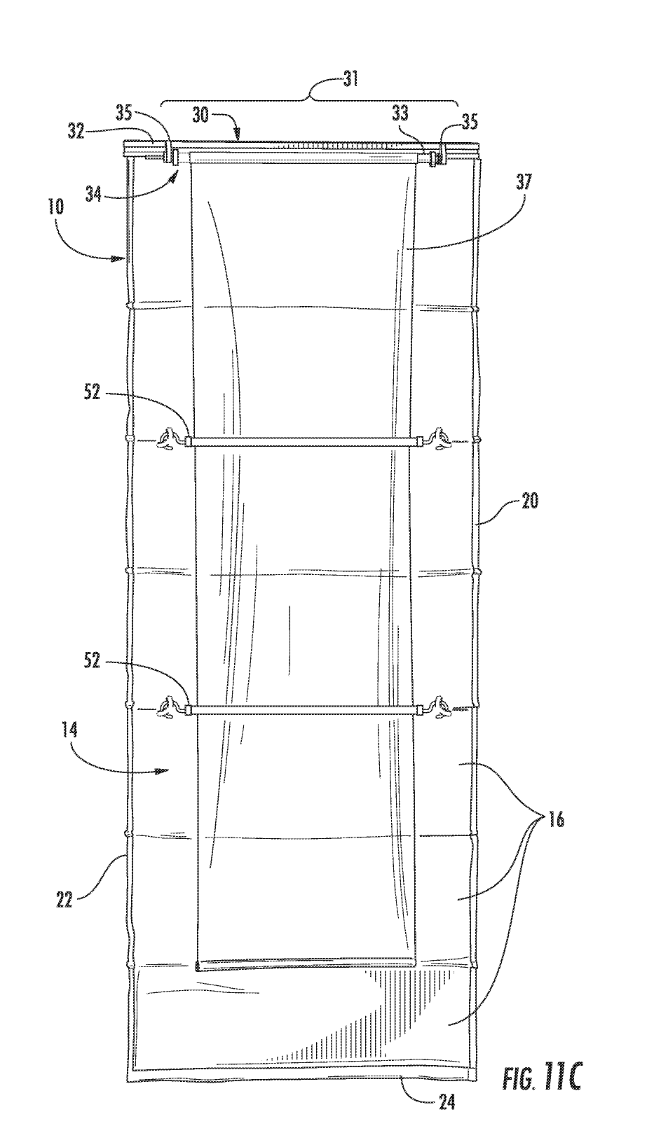

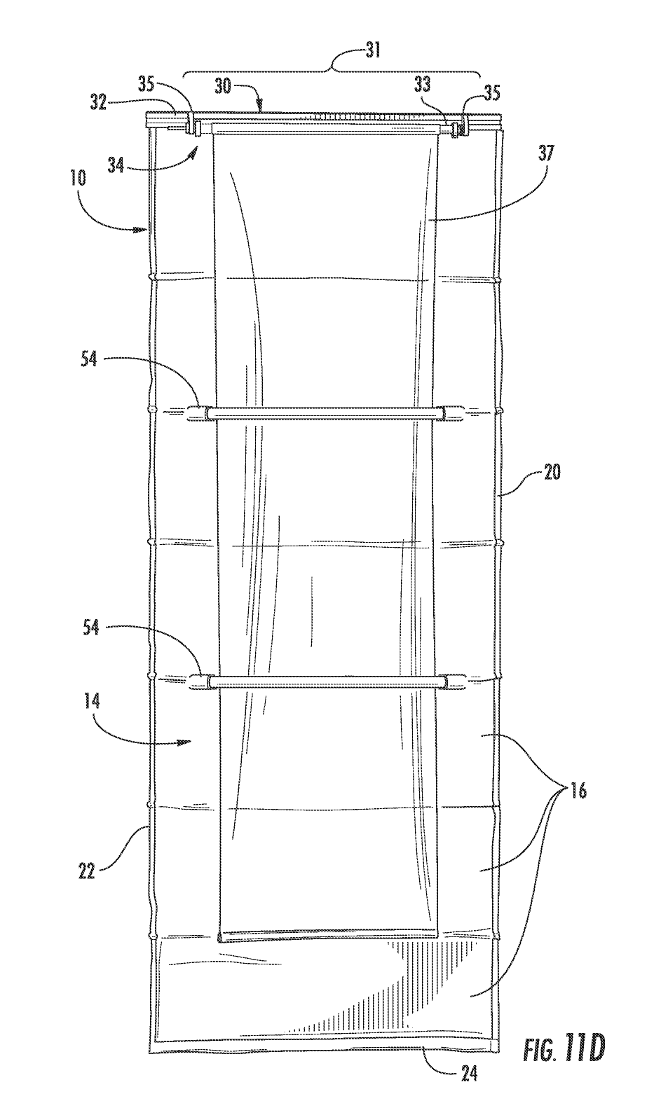

Referring now to FIGS. 11a-11d, instead of a clip 40, a unitary wire loop 48, wire hooks 50, unitary rod 52, or a cloth loop 54 may also be used. The critical factor is that the guides must allow the lifting member 37 to travel freely through the guide without undue snagging or resistance.

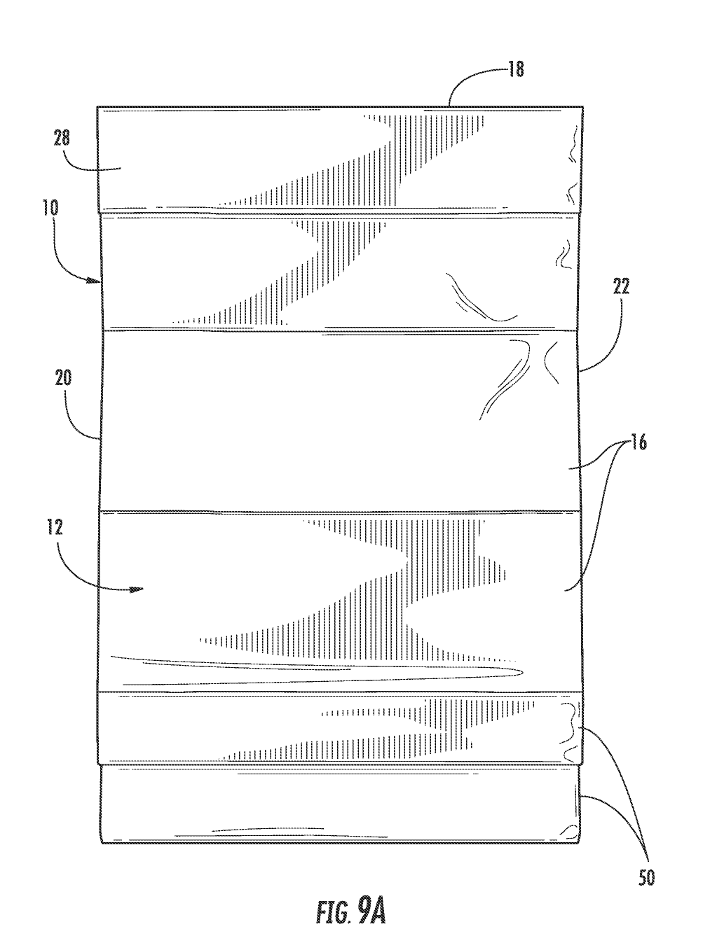

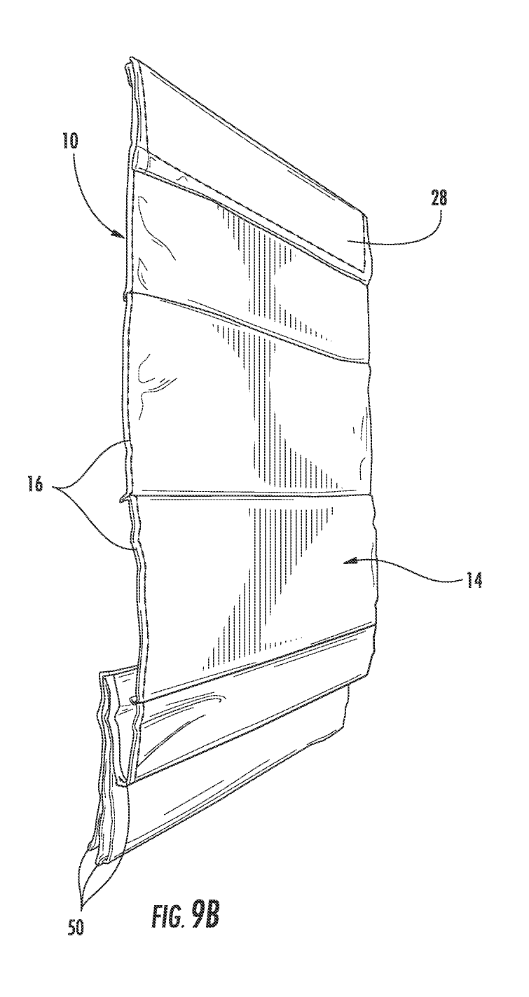

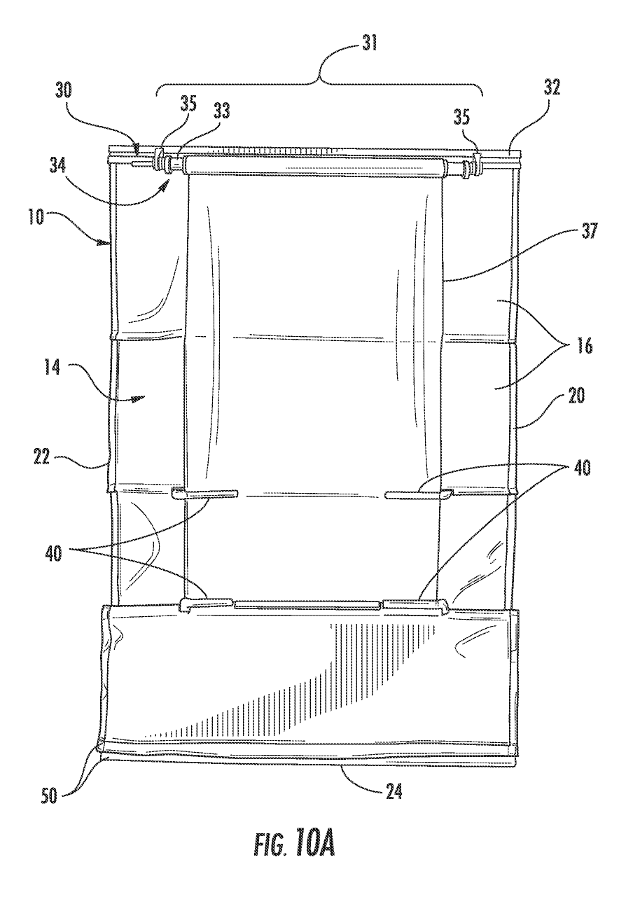

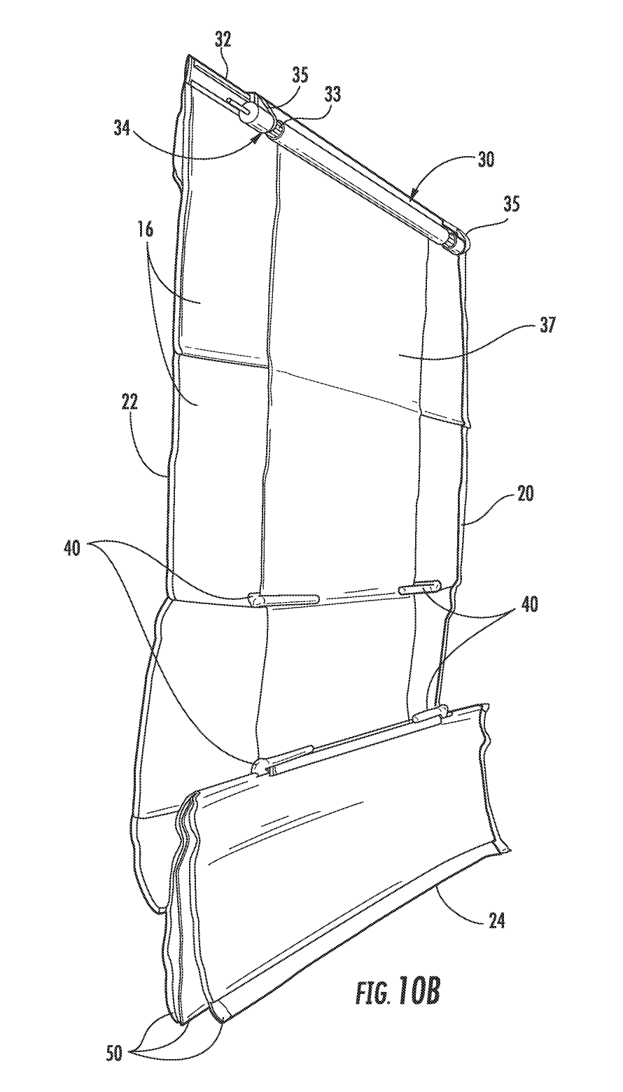

Referring to FIGS. 9a, 9b, 10a and 10b, the clips 40 guide the lifting member 37 as the take up member 33 gathers the lifting member 37 when the take up member 33 is rotated thereby causing the window treatment 10 to fold upon itself as the clips 40 are drawn together, forming decorative pleats 50 in the window treatment 10. When the take member 33 is rotated in the opposite direction the take up member 33 releases the lifting member 37 causing the window treatment 10 to close. The lifting mechanism 34 is configured to gather and release the lifting member 37.

Therefore, it can be seen that the present invention provides a unique solution to the problem of providing an interchangeably window treatment for a Roman-style shade that permits the user to easily remove, clean and replace the window treatment, or interchange a window treatment for another more desirable window treatment.

It would be appreciated by those skilled in the art that various changes and modifications can be made to the illustrated embodiments without departing from the spirit of the present invention. All such modifications and changes are intended to be within the scope of the present invention except insofar as limited by the appended claims.

What is claimed is:

1. A window treatment, comprising:
a panel having a front portion, a rear portion, a top edge and a bottom edge; and
a plurality of guides extending from the rear portion of the panel, said guides configured and arranged to allow a lifting mechanism to slide therethrough.

2. The window treatment of claim 1, further comprising a fastener extending from the top edge.

3. The window treatment of claim 1, further comprising a fastener extending from the rear portion.

4. The window treatment of claim 2, wherein the fastener is a hook-and-loop fastener.

5. The window treatment of claim 2, wherein the fastener is a plurality of buttons.

6. The window treatment of claim 3, wherein the fastener is a hook-and-loop fastener.

7. The window treatment of claim 3, wherein the fastener is a plurality of buttons.

8. The window treatment of claim 1, further comprising a plurality of pleats formed therein.

9. The window treatment of claim 8, wherein the pleats are formed horizontally.

10. The window treatment of claim 1, wherein the guides are formed from pockets formed on the rear portion of the panel.

11. The window treatment of claim 1, wherein the guides comprise a clip including a first element and a second guide element spaced apart from the first guide element.

12. The window treatment of claim 1, wherein the clip further comprises a clip portion configured and arranged to attach to the rear portion of the panel.

13. The window treatment of claim 1, further comprising a valance portion extending from the top edge of the panel.

14. A guide for a roll-up window treatment, comprising:
a clip portion configured and arranged to attached to a window treatment; and
a guide portion extending from the clip portion configured and arranged to slidably receive an edge of a lifting mechanism therein.

15. The guide of claim 14, wherein the guide portion comprises:
a first guide element; and
a second guide element spaced-apart from the first guide element forming a slot;
the slot slidably receiving an edge of a lifting mechanism therein and between the first guide element and the second guide element.

16. The guide of claim 14, further comprising a tooth on the clip portion.

17. The guide of claim 15, further comprising a tooth on the second guide element.

18. The guide of claim 14, wherein the clip portion further comprises a retaining element spaced apart from the second guide element.

19. The guide element of claim 18, further comprising a tooth on the retaining element facing the second guide element.

20. The guide element of claim 18, further comprising a tooth on the second guide element facing the retaining element.

21. A window treatment, comprising:
a lifting mechanism; and
a panel having a front portion, a rear portion, a top edge and a bottom edge;
the panel configured and arranged to removably attached to the lifting mechanism.

22. The window treatment of claim 22, further comprising a head rail, the panel configured and arranged to removably attached to the head rail.

23. The window treatment of claim 21, wherein the lifting mechanism is cordless.

24. A window treatment, comprising:
a head rail; and
a panel having a front portion, a rear portion, a top edge and a bottom edge;
the panel configured and arranged to removably attached to the head rail.

25. The window treatment of claim 24, further comprising a lifting mechanism, the panel configured and arranged to removably attached to the lifting mechanism.

26. The window treatment of claim 24, wherein the lifting mechanism is cordless.

26. A window treatment, comprising:
a head rail;
a lifting mechanism; and
a panel having a front portion, a rear portion, a top edge and a bottom edge;
the panel configured and arranged to removably attached to the lifting mechanism and the head rail.

27. The window treatment of claim 26, wherein the lifting mechanism is cordless.
